(19) United States
(12) Patent Application Publication
(10) Pub. No.: US 2010/0161397 A1
(43) Pub. Date: Jun. 24, 2010

(54) Facilitating Customer Recycling of Mobile Device

(75) Inventors: Alain Gauthier, Montreal (CA); Cesar Chirino, Col. Carola (MX); Hariharan Arumugam, Cupertino, CA (US); Jonathan Viau, St. Hubert (CA); Marc Bernard, Northfield, IL (US); Subramaniam Raman, Santa Clara, CA (US)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/343,703

(22) Filed: Dec. 24, 2008

(51) Int. Cl. G06F 3/048; G01C 21/00; G06F 15/16; G06Q 30/00

(52) U.S. Cl. 705/14.4; 715/709; 701/300; 709/206

(57) ABSTRACT

Among other disclosed subject matter, a computer program product is tangibly embodied in a computer-readable storage medium and includes instructions that when executed by a processor perform a method for facilitating customer recycling of a mobile device. The method includes receiving an input in a mobile device from a user, the input initiating execution of program code configured to automatically present the user up-to-date instructions on how to recycle the mobile device. The method includes presenting, in response to the input, the up-to-date instructions on a display of the mobile device.

### TECHNICAL FIELD

This document relates to device recycling.

### BACKGROUND

Electronic devices can include a multitude of different components. Some components are purely functional and can include circuitry, processors or other electronics that are involved in the basic operation of the device. Other components can have also an ornamental or design purpose, such as an outer shell or housing that contains the rest of the components, which can be stylized in colors and/or particular materials. For some types of devices, the life expectancy is significantly shorter than that of the user; that is, a typical user does not use the same device indefinitely but rather can be expected to acquire another device to replace the old device one or more times.

The combination of different components and/or materials in a device can make the post-use disposal an important concern. For example, circuits or other electronics can include materials that will last for a very long time after the device is no longer used, and some materials may be harmful if not disposed of properly. For these and other reasons, device recycling has been suggested as a useful way to attempt to recapture some materials from the device for possible reuse and/or to eliminate or reduce the risk from harmful materials.

### SUMMARY

The invention relates to facilitating recycling of a mobile device.

In a first aspect, a computer program product is tangibly embodied in a computer-readable storage medium and includes instructions that when executed by a processor perform a method for facilitating customer recycling of a mobile device. The method includes receiving an input in a mobile device from a user, the input initiating execution of program code configured to automatically present the user up-to-date instructions on how to recycle the mobile device. The method includes presenting, in response to the input, the up-to-date instructions on a display of the mobile device.

Implementations can include any or all of the following features. Presenting the up-to-date instructions can include presenting the user at least first and second ways of recycling the mobile device, the up-to-date instructions providing that the user can choose between the at least first and second ways of recycling the mobile device. The user can choose the first way of recycling the mobile device, and the method can further include determining a current location of the mobile device; determining a nearest location of a recycling facility that accepts recycling of the mobile device; and presenting, on the display and in response to the user choosing the first way, geographical directions from the current location to the nearest location. The user can choose the second way of recycling the mobile device, and the method can further include forwarding a message from the mobile device in response to the user choosing the second way, the message specifying a current location of the mobile device and requesting a transportation container for sending the mobile device to a recycling facility. The method can further include forwarding, to a server device operated by a manufacturer of the mobile device, a confirmation that the mobile device is being recycled. The method can further include receiving, from the server device, a marketing message relating to recycling the mobile device. The method can further include identifying, from among information stored in a memory on the mobile device, an information subset that includes personal information or confidential information; storing the information subset on a removable medium configured so that the information subset remains on the removable medium after the removable medium is detached from the mobile device; and removing at least the information subset from the memory. The method can further include identifying, from among information stored in a memory on the mobile device, an information subset that includes personal information or confidential information associated with the user; forwarding the information subset to the server device, the server device configured to provide a download of the information subset to another mobile device operated by the user as a replacement for the mobile device; and removing at least the information subset from the memory. The method can further include receiving, before the input is received, a download of an information subset that includes personal information or confidential information associated with the user, the information subset received from a server device that is operated by a manufacturer of the mobile device and that received the information subset as an upload from another mobile device that was previously operated and recycled by the user. The mobile device can include or be part of: a cellular telephone, a handheld device, a personal digital assistant, a wireless communication device, a music player, a portable computer device, a laptop computer, a vehicle, an appliance, a television set, a camera, and combinations thereof.

In a second aspect, a computer program product is tangibly embodied in a computer-readable storage medium and includes instructions that when executed by a processor perform a method for facilitating customer recycling of a mobile device. The method includes storing, on a mobile device, an application program to be initiated by a user of the mobile device, the application program configured to automatically present the user up-to-date instructions on how to recycle the mobile device.

Implementations can include any or all of the following features. The computer program product can be configured so that the method is performed by a manufacturer of the mobile device and the storing is performed before the mobile device is delivered to the user. The method can further include forwarding the up-to-date instructions to the mobile device for presentation on a display of the mobile device. The method can further include receiving, after forwarding the up-to-date instructions, a confirmation that the mobile device is being recycled. The confirmation can be received from a recycling facility, the confirmation generated at the recycling facility upon recycling of the mobile device. The method can further include presenting, in a graphical user interface, recycling statistics regarding a device model of the mobile device, the recycling statistics generated based at least on the confirmation. The application program can further be configured to automatically preserve personal information or confidential information associated with the user in connection with recycling the mobile device. The mobile device can include or be part of: a cellular telephone, a handheld device, a personal digital assistant, a wireless communication device, a music player, a portable computer device, a laptop computer, a vehicle, an appliance, a television set, a camera, and combinations thereof.

In a third aspect, a mobile device includes a processor, a display device operatively connected to the processor, and a tangible storage medium having stored therein an application program to be initiated by a user of the mobile device, the application program configured to automatically present on the display device, when executed by the processor, up-to-date instructions on how to recycle the mobile device.

In implementations, the mobile device can further include a removable medium configured so that an information subset remains on the removable medium after the removable medium is detached from the mobile device, the information subset identified from among the information, in connection with recycling the mobile device, as including personal information or confidential information associated with the user.

Implementations can provide any or all of the following advantages. Customer recycling of a mobile device can be facilitated. A solution can be developed that places up-to-date recycling instructions on the mobile device itself. The user can be offered practical options to choose between for recycling a device.

The details of one or more embodiments are set forth in the accompanying drawings and the description below. Other features and advantages will be apparent from the description and drawings, and from the claims.

### DESCRIPTION OF DRAWINGS

FIG. 1 shows an example system that can facilitate customer recycling of a mobile device.

FIGS. 2A-D show examples of a graphical user interface that can be generated regarding recycling a mobile device.

FIG. 3 shows an example graphical user interface that can present recycling statistics to a manufacturer of a mobile device.

FIG. 4 is a block diagram of a computing system that can be used in connection with computer-implemented methods described in this document.

Like reference symbols in the various drawings indicate like elements.

### DETAILED DESCRIPTION

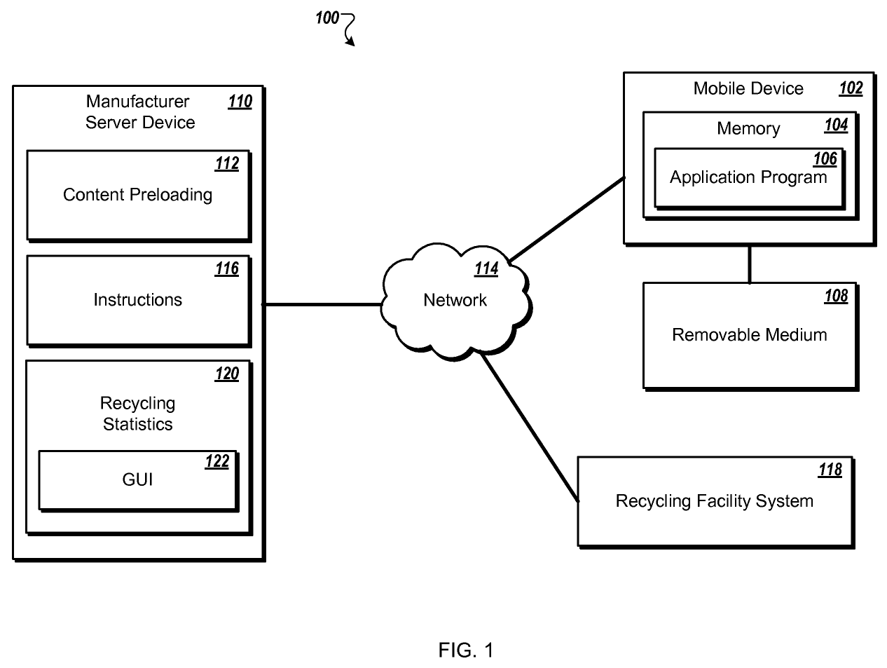

FIG. 1 shows an example system 100 that can facilitate customer recycling of a mobile device. Here, the system 100 includes at least one mobile device 102, such as a cellular telephone or any other handheld device. In some implementations, a user of the mobile device 102 can receive up-to-date instructions for recycling the mobile device. For example, the user can be provided travel directions to a nearest recycling center or a free shipping box for returning the mobile device for recycling. The travel directions and/or box delivery can be initiated and administered using a program that the manufacturer may have loaded on the device before it was purchased.

In some examples herein, the mobile device 102 will be referred to as an Internet-connected cellular telephone. Many other types of devices or other products can constitute the mobile device 102, or the device can include such devices/products. For example, the mobile device can include, or be part of: any kind of cellular telephone, a handheld device, a personal digital assistant, a wireless communication device, a music player, a portable computer device, a laptop computer, a vehicle, an appliance, a television set, a camera, and combinations thereof.

In some implementations, the mobile device 102 includes a processor and a display device. For example, a processor manufactured for installation in a computer or in a cellular telephone can be used. The mobile device 102 can include a display device, such as a monitor or other display receiving output signals generated by the processor. The mobile device 102 can include a tangible storage medium 104, such as a memory, drive unit, or any other form of storage for digital information.

The mobile device 102 can have stored thereon an application program 106, for example in the memory 104. In some implementations, the program 106 can be initiated by a user of the mobile device 102 for instructions and/or other assistance regarding recycling of the mobile device 102. For example, the program 106 can present the user with up-to-date instructions on how to recycle the mobile device. The program 106 may have been loaded onto the device 102 during a manufacturing process, or it may be downloaded to the device at a later time, to name just two examples.

The mobile device 102 can include a removable medium 108. In some implementations, when the device 102 is to be recycled, the application program 106 can find personal or confidential information on the mobile device and automatically load it onto the removable medium 108. For example, personal information such as emails, calendar entries and contact records can be loaded onto the medium 108, such as onto a flash memory card, before the application program 106 erases that information from the mobile device 102 to prevent that an unauthorized person gets access to the information before, during or after the device 102 is actually recycled.

In the system 100, a manufacturer server device 110 can be operated by an entity that manufactures the mobile device 102. The manufacturer can employ a complex production facility for making and/or assembling the mobile device 102, and such facility is not explicitly shown here for clarity. However, the server device 110 can include a content preloading component 112 that can be involved in at least part of the manufacturing of the mobile device. In some implementations, the content preloading component 112 can include code corresponding to the application program 106 and cause that code to be preloaded on the mobile device 102 at the manufacturer's facilities, before the device is delivered to a store or to the customer. Other content can be preloaded on the mobile device in addition to the application program 106, such as an operating system and/or one or more other program components, such as an internet browser.

The manufacturer server device 110 and the mobile device 102 can be connected to one or more networks 114, such as to a private communication network or to the Internet. The server device 110 can communicate with the mobile device 102 and/or with another system using the network 114. For example, the server device can provide recycling instructions to the user of the mobile device. In some implementations, the server device 110 includes an instructions module 116 that can generate up-to-date instructions. For example, the instructions module 116 can use addresses of recycling facilities to provide road travel instructions for the user of the mobile device to the recycling facility nearest the user's current location. As another example, the instructions module 116 can receive a current address of the mobile user and can cause a shipping box to be delivered to the address so that the user can conveniently send the mobile device for recycling.

A confirmation of the recycling can be forwarded to the manufacturer, for example by a communication using the network 114. For example, the user of the mobile device 102 can generate the confirmation upon deciding that the device is actually going to be recycled. In some implementations, a confirmation can be generated by another entity, such as by the recycling organization. For example, the system 100 can include a recycling facility system 118. The recycling entity can employ a complex recycling facility for disassembling the mobile device 102 and/or reducing it to its component raw materials, and such facility is not explicitly shown here for clarity. However, the recycling facility system 118 can register an identity number of the device being recycled (such as a unique code found on or in a cellular telephone), and using this number can confirm to the manufacturer that the device is being recycled. Other forms of confirming recycling can be used.

The manufacturer can collect and/or review statistics regarding recycling. In some implementations, the manufacturer server device 110 can include a recycling statistics module 120 that can gather, process and present information that indicates one or more aspects relating to the recycling of the manufacturer's device(s). For example, the confirmation received regarding the mobile device 102 can be used to generate a statistical output that is presented on a graphical user interface (GUI) 122.

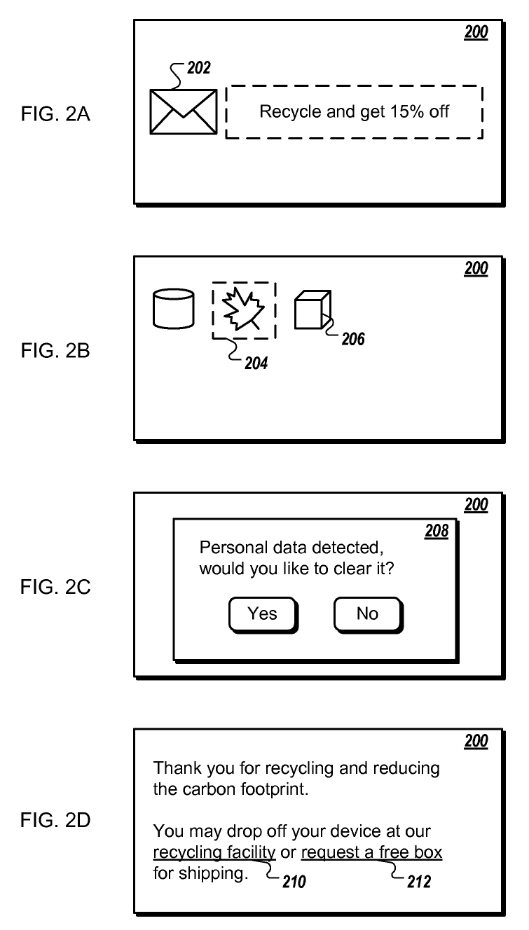

FIGS. 2A-D show examples of a GUI 200 that can be generated regarding recycling a mobile device. The GUI 200 can be generated on a display device of the mobile device 102 or on another device, to name just two examples.

In FIG. 2A, the GUI 200 schematically illustrates that an email 202 has been received. In some implementations, the email 202 can be sent from the manufacturer server device 110 for receipt by the mobile device 102. For example, the manufacturer can use the GUI 122 (FIG. 1) to view recycling statistics for a particular type of device, and can then use the GUI 122 to directly create a marketing campaign directed to owners/users of that type of device. The email 202 is an example of a message that can be generated in a marketing campaign and can in some implementations encourage the user to properly recycle the device (as opposed to, say, merely throwing away the device). For example, the user can be offered a rebate (e.g., 15% discount on a new mobile device) for complying with the recycling procedure. Moreover, the email 202 can provide instructions to the user for recycling the mobile device. In some implementations, the email directs the user to a recycling application on the mobile device 106, such as the application program 106, which can present detailed instructions. For example, the email 202 can include an electronic link to the program or explain to the user how to launch the program.

In this example, the program 106 (FIG. 1) can be launched using an icon 204 visible on a desktop background of the GUI 200. One or more other icons 206 can also be located on the desktop. In some implementations, the icon 204 can be used to obtain recycling instructions regardless of whether the user has received and/or opened the email 202. In this example, the user launches the program by selecting the icon 204.

FIG. 2C shows an example appearance of the GUI 200 after execution of the program 106 has been initiated. Here, a dialog message 208 is generated by the program and informs the user that personal data has been detected on the mobile device. For example, the program 106 can be configured to scan all or part of the memory 104 for information that might be personal to the user (i.e., information in address books, etc., that has been manually entered) or otherwise confidential (e.g., company-specific information). The program 106 can offer one or more ways of dealing with detected information. For example, here the dialog message 208 asks whether the detected information should be cleared, and the user can enter yes or no in response. If the user replies yes, the program 106 can remove any detected personal and/or confidential data from the memory 104. If the user replies no, the information can remain on the device.

In some implementations, information on the mobile device can be stored elsewhere in preparation for recycling. For example, personal and/or confidential information in the memory 104 can be transferred to the removable medium 108, such as on a flash card or any other computer-readable medium. In some implementations, the user can make an input to the application program 106 to trigger the storing of the information on the medium 108. After the information has been stored on the medium 108, the user can connect the removable medium 108 to another device and access some or all of the information from that device. For example, if the user upgrades to a newer model of the device that is being recycled, the removable medium 108 can be used with the new device to provide an essentially continuous mobile connectivity for the user.

As another example, personal and/or confidential information in the memory 104 can be transferred to another device, such as through the network 114. In some implementations, the application program 106 uploads the information from the mobile device 102 (e.g., after the user has triggered this operation) to the manufacturer server device 110. For example, the uploaded information can be preserved and made available to the user (e.g., through a secure login and download routine) for use on another device, such as on a new mobile device that replaces the recycled mobile device 102.

Along the lines of the above two examples, the personal and/or confidential information on the device 102 may initially have come from another device where it was detected as part of a recycling procedure. For example, the information may have been placed on the mobile device 102 using the removable medium 108 and/or a download from the manufacturer server device 110. Other approaches can be used.

FIG. 2D shows an example appearance of the GUI 200 that can provide the user up-to-date instructions on how to recycle the mobile device 102. In some implementations, the GUI 200 can include a directions link 210 that provides the user road directions to a recycling facility. For example, the application program 106 can determine a current location of the mobile device 102 (such as using Global Positioning System or other geographic location tool) and use this information to identify a nearest recycling center from a directory. The application program 106 can provide turn-by-turn directions from the current location to the identifier recycling facility, for example using a navigation component.

As another example, the GUI 200 can include a free-box link 212 that triggers shipment of a transportation container (e.g., a box in which to place the mobile device) to the user. In some implementations, selection of the link 212 can generate a message to the manufacturer server device 110 that identifies the user and/or the mobile device, and that triggers automatic labeling of the package of the transportation container with the user's current address for shipping the container to the user. The container, in turn, can be marked with a destination address where the mobile device should be delivered for recycling. For example, the container can be marked with the address of the recycling facility or of the manufacturer.

A confirmation that the mobile device 102 is being recycled can be generated. In some implementations, the confirmation can be generated to the manufacturer server device 110. For example, the user can select an option in the application program 106 that verifies to the manufacturer that the user intends to recycle the device. As another example, the confirmation can be generated by an operator of the recycling facility system 118 (FIG. 1).

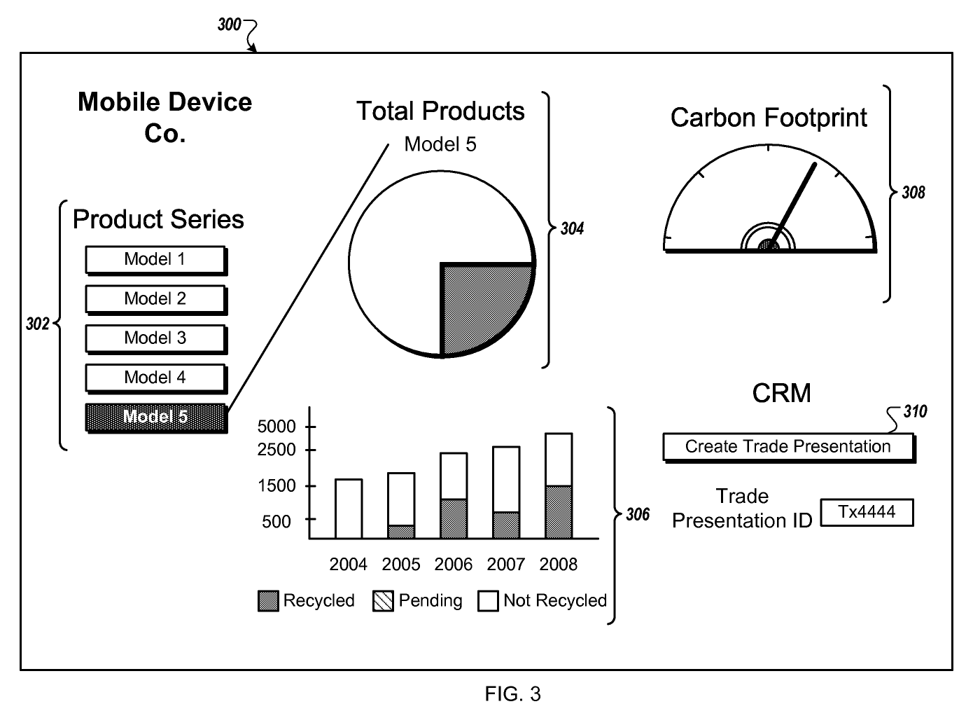

FIG. 3 shows an example GUI 300 that can present recycling statistics to a manufacturer of a mobile device. In some implementations, the GUI 300 can be used with the recycling statistics module 120 (FIG. 1) and can be included in, or can include, the GUI 122. Here, the GUI 300 includes a control 302 for choosing between models of devices. For example, the user can select a particular model and be presented with recycling statistics regarding that model. In some implementations, such statistics can be generated based at least in part on recycling confirmations

In some implementations, recycling statistics can be presented in a chart 304. For example, the chart 304 can indicate, for the total products of the selected model that have been sold, the percentages of the devices that have been recycled or not recycled.

In some implementations, recycling statistics can be presented in a graph 306. For example, the graph 306 can show year-by-year statistics regarding the recycling of a selected device model. In some implementations, the statistics can be divided in two or more segments, such as to show the proportions of devices that have been recycled; where recycling is pending; and that have not been recycled.

In some implementations, recycling statistics can be presented in a carbon footprint gauge 308. For example, the carbon footprint of devices can be calculated based at least in part on the proportion of devices that are being recycled.

The GUI 300 can include a control 310 for initiating a marketing campaign. In some implementations, the GUI 300 is integrated with a CRM application (such as in the manufacturer server device 110) and the control 310 can launch a marketing component of the CRM application. For example, the marketing campaign can be directed to owners of devices whose type is selected in the control 302. In some implementations, the marketing campaign can include sending the email 202 to the owners.

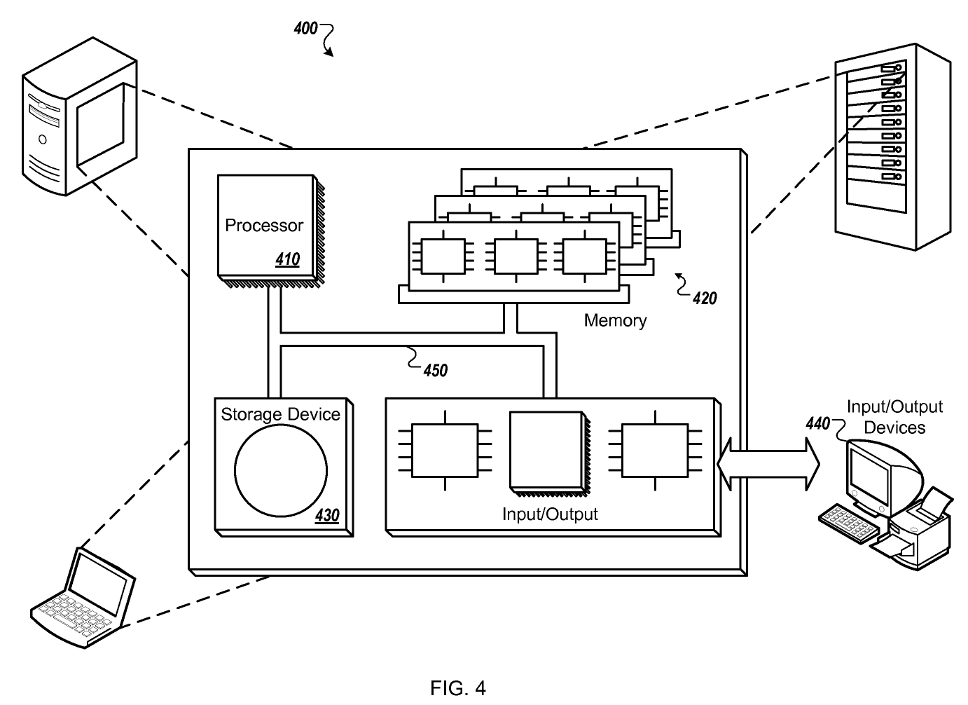

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer program product tangibly embodied in a computer-readable storage medium and comprising instructions that when executed by a processor perform a method for facilitating customer recycling of a mobile device, the method comprising:
receiving an input in a mobile device from a user, the input initiating execution of program code configured to automatically present the user up-to-date instructions on how to recycle the mobile device; and
presenting, in response to the input, the up-to-date instructions on a display of the mobile device.

2. The computer program product of claim 1, wherein presenting the up-to-date instructions comprises presenting the user at least first and second ways of recycling the mobile device, the up-to-date instructions providing that the user can choose between the at least first and second ways of recycling the mobile device.

3. The computer program product of claim 2, wherein the user chooses the first way of recycling the mobile device, the method further comprising:
determining a current location of the mobile device;
determining a nearest location of a recycling facility that accepts recycling of the mobile device; and
presenting, on the display and in response to the user choosing the first way, geographical directions from the current location to the nearest location.

4. The computer program product of claim 2, wherein the user chooses the second way of recycling the mobile device, the method further comprising:
forwarding a message from the mobile device in response to the user choosing the second way, the message specifying a current location of the mobile device and requesting a transportation container for sending the mobile device to a recycling facility.

5. The computer program product of claim 1, further comprising:
forwarding, to a server device operated by a manufacturer of the mobile device, a confirmation that the mobile device is being recycled.

6. The computer program product of claim 5, further comprising:
receiving, from the server device, a marketing message relating to recycling the mobile device.

7. The computer program product of claim 5, further comprising:
identifying, from among information stored in a memory on the mobile device, an information subset that includes personal information or confidential information;
storing the information subset on a removable medium configured so that the information subset remains on the removable medium after the removable medium is detached from the mobile device; and
removing at least the information subset from the memory.

8. The computer program product of claim 5, further comprising:
identifying, from among information stored in a memory on the mobile device, an information subset that includes personal information or confidential information associated with the user;
forwarding the information subset to the server device, the server device configured to provide a download of the information subset to another mobile device operated by the user as a replacement for the mobile device; and
removing at least the information subset from the memory.

9. The computer program product of claim 1, further comprising:
receiving, before the input is received, a download of an information subset that includes personal information or confidential information associated with the user, the information subset received from a server device that is operated by a manufacturer of the mobile device and that received the information subset as an upload from another mobile device that was previously operated and recycled by the user.

10. The computer program product of claim 1, wherein the mobile device includes or is part of: a cellular telephone, a handheld device, a personal digital assistant, a wireless communication device, a music player, a portable computer device, a laptop computer, a vehicle, an appliance, a television set, a camera, and combinations thereof.

11. A computer program product tangibly embodied in a computer-readable storage medium and comprising instructions that when executed by a processor perform a method for facilitating customer recycling of a mobile device, the method comprising:
storing, on a mobile device, an application program to be initiated by a user of the mobile device, the application program configured to automatically present the user up-to-date instructions on how to recycle the mobile device.

12. The computer program product of claim 11, wherein the computer program product is configured so that the method is performed by a manufacturer of the mobile device and the storing is performed before the mobile device is delivered to the user.

13. The computer program product of claim 11, wherein the method further comprises:
forwarding the up-to-date instructions to the mobile device for presentation on a display of the mobile device.

14. The computer program product of claim 13, wherein the method further comprises:
receiving, after forwarding the up-to-date instructions, a confirmation that the mobile device is being recycled.

15. The computer program product of claim 14, wherein the confirmation is received from a recycling facility, the confirmation generated at the recycling facility upon recycling of the mobile device.

16. The computer program product of claim 14, wherein the method further comprises:
presenting, in a graphical user interface, recycling statistics regarding a device model of the mobile device, the recycling statistics generated based at least on the confirmation.

17. The computer program product of claim 11, wherein the application program is further configured to automatically preserve personal information or confidential information associated with the user in connection with recycling the mobile device.

18. The computer program product of claim 11, wherein the mobile device includes or is part of: a cellular telephone, a handheld device, a personal digital assistant, a wireless communication device, a music player, a portable computer device, a laptop computer, a vehicle, an appliance, a television set, a camera, and combinations thereof.

19. A mobile device comprising:
a processor;
a display device operatively connected to the processor; and
a tangible storage medium having stored therein an application program to be initiated by a user of the mobile device, the application program configured to automatically present on the display device, when executed by the processor, up-to-date instructions on how to recycle the mobile device.

20. The mobile device of claim 19, wherein the tangible storage medium contains information, the mobile device further comprising:
a removable medium configured so that an information subset remains on the removable medium after the removable medium is detached from the mobile device, the information subset identified from among the information, in connection with recycling the mobile device, as including personal information or confidential information associated with the user.
